(19) United States
(12) Patent Application Publication
(10) Pub. No.: US 2023/0345344 A1
(43) Pub. Date: Oct. 26, 2023

(54) SIGNAL TRANSMISSION AND RECEPTION METHOD AND APPARATUS AND COMMUNICATION SYSTEM

(71) Applicant: FUJITSU LIMITED, Kawasaki-shi (JP)

(72) Inventors: Su YI, Beijing (CN); Meiyi JIA, Beijing (CN); Lei ZHANG, Beijing (CN); Xin WANG, Beijing (CN)

(73) Assignee: FUJITSU LIMITED, Kawasaki-shi (JP)

(21) Appl. No.: 18/218,628

(22) Filed: Jul. 6, 2023

Related U.S. Application Data
(63) Continuation of application No. PCT/CN2021/071591, filed on Jan. 13, 2021.

(51) Int. Cl. H04W 40/22; H04W 24/10; H04W 28/02

(52) U.S. Cl. CPC H04W 40/22; H04W 24/10; H04W 28/0284; H04W 28/0278

(57) ABSTRACT

A signal transmission and reception apparatus, applicable in an integrated access and backhaul (IAB)-node, includes a transmitter, configured to transmit a congestion reporting message to a donor central unit of the integrated access and backhaul node (IAB-donor CU), the congestion reporting message being used to indicate a load status of a communication link of the integrated access and backhaul node.

### CROSS-REFERENCE TO RELATED APPLICATION

This application is a continuation application of International Application PCT/CN2021/071591 filed on Jan. 13, 2021, and designated the U.S., the entire contents of which are incorporated herein by reference.

### TECHNICAL FIELD

This disclosure relates to the field of communication technologies.

### BACKGROUND

Integrated access and backhaul (IAB) enables a function of wireless relay in a next generation radio access network (NG-RAN). An integrated access and backhaul node (IAB-node) supports access and backhaul via New Radio (NR). A termination point of NR backhaul at a network side is referred to as an IAB-donor, which denotes a network device (e.g. a gNB) supporting an IAB function.

An IAB-node is connected to an IAB-donor via one or more hops. These multi-hop connections form a directed acyclic graph (DAG) topological structure with an IAB-donor as a root node. The IAB-donor is responsible for executing centralized resource management, topology management and routing management in an IAB network topology.

The IAB-node supports a function of a gNB-DU (distributed unit), and an IAB-node DU is also referred to as an IAB-DU, which is a terminating point of a New Radio access (NR access) interface to a terminal equipment (UE) and a next hop of IAB-node and is also a terminating point of an F1 protocol to a gNB-CU (central unit) on the IAB-node. The IAB-DU may serve for a common UE and an IAB child node.

In addition to the function of the gNB-DU, the IAB-node also supports some functions of the UE, referred to as an IAB-MT (mobile termination). The IAB-MT includes, for example, a physical layer, layer 2, RRC and NAS functions to be connected to a gNB-DU on another IAB-node or IAB-donor, a gNB-CU on the IAB-donor and a core network. The IAB-MT may support such functions as a UE physical layer, an access stratum (AS), a radio resource control (RRC) layer and a non-access stratum (NAS), and may be connected to an IAB parent node.

FIG. 1 is a schematic diagram of the IAB topological structure. As shown in FIG. 1, in an IAB topological structure 10, an IAB-node 100 includes an IAB-MT functional unit 101 and an IAB-DU functional unit 102, neighboring nodes connected to an interface of the IAB-DU functional unit 102 are referred to as child nodes, such as child nodes 201, 202 and 203 shown in FIG. 1, the IAB-DU functional unit 102 may be in communication with the child nodes 201, 202 and 203 via an air interface (Uu), neighboring nodes connected to an interface of the IAB-MT functional unit 101 are referred to as parent nodes, such as parent nodes 301 and 302 shown in FIG. 1, and the IAB-MT functional unit 101 may be in communication with the parent nodes 301 and 302 via an air interface (Uu).

As shown in FIG. 1, a direction from the IAB-node 100 to the child nodes 201, 202 and 203 is referred to as a downstream direction, and a direction from the IAB-node 100 to the parent nodes 301 and 302 is referred to as an upstream direction. And an IAB-donor (not shown) executes centralized resource management, topology management and routing management for the IAB topological structure 10.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY OF THE DISCLOSURE

It is possible that congestion occurs when a data rate at an ingress of the IAB-node does not match with a data rate at an egress thereof.

It was found by the inventors that there exist certain limitations in existing methods for alleviating congestion. For example, a problem of long-term congestion cannot be solved, available particular modes for alleviating congestion are limited, and uplink congestion cannot be alleviated.

In order to solve at least one of the above problems, embodiments of this disclosure provide a signal transmission and reception method and apparatus and a communication system, in which an integrated access and backhaul node (IAB-node) transmits a congestion reporting message to an IAB-donor central unit (IAB-donor CU). Hence, the IAB-donor central unit (IAB-donor CU) is able to use a control plane (CP) based method to alleviate congestion of the IAB-node.

According to an aspect of the embodiments of this disclosure, there is provided a signal transmission and reception apparatus, applicable in an IAB-node, including:
a first transmitting and receiving unit configured to transmit a congestion reporting message to a donor central unit of the integrated access and backhaul node (IAB-donor CU), the congestion reporting message being used to indicate a load status of a communication link of the integrated access and backhaul node.

According to another aspect of the embodiments of this disclosure, there is provided a signal transmission and reception apparatus, applicable in a donor-CU, comprising:
a third transmitting and receiving unit configured to receive a congestion reporting message transmitted by an integrated access and backhaul (IAB) node, the congestion reporting message being used to indicate a load status of a communication link of the integrated access and backhaul node.

According to a further aspect of the embodiments of this disclosure, there is provided a signal transmission and reception method, including: Transmitting, by an integrated access and backhaul (IAB) node, a congestion reporting message to a donor central unit of the integrated access and backhaul node (IAB-donor CU), the congestion reporting message being used to indicate a load status of a communication link of the integrated access and backhaul node.

According to still another aspect of the embodiments of this disclosure, there is provided a signal transmission and reception method, including:
receiving, by a donor central unit (IAB-donor CU), a congestion reporting message transmitted by an integrated access and backhaul (IAB) node, the congestion reporting message being used to indicate a load status of a communication link of the integrated access and backhaul node.

An advantage of the embodiments of this disclosure exists in that the IAB-node transmits the congestion reporting message to the IAB-donor CU; hence, the IAB-donor CU is able to alleviate congestion of the IAB-node in a method based on a CP.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of an IAB topological structure;

FIG. 2 is a schematic diagram of hop-by-hop downlink flow control;

FIG. 3 is a schematic diagram of a signal transmission and reception method of an embodiment of a first aspect of this disclosure;

FIG. 4 is a schematic diagram of indicating a load status of a downlink by a congestion reporting message in the embodiment of the first aspect of this disclosure;

FIG. 5 is a schematic diagram of indicating a load status of an uplink by a congestion reporting message in the embodiment of the first aspect of this disclosure;

FIG. 6 is a schematic diagram of triggering, by the IAB-donor CU 6 via polling information, the IAB-node 3 to transmit a congestion reporting message;

FIG. 7 is a schematic diagram of transmitting congestion reporting configuration information by the IAB-donor CU 6 to the IAB-node 3;

FIG. 8 is another schematic diagram of triggering, by the IAB-donor CU 6 via polling information, the IAB-node 3 to transmit a congestion reporting message;

FIG. 9 is a schematic diagram of a signal transmission and reception method of an embodiment of a second aspect;

FIG. 10 is a schematic diagram of a signal transmission and reception apparatus of an embodiment of a third aspect;

FIG. 11 is a schematic diagram of a signal transmission and reception apparatus of an embodiment of a fourth aspect;

FIG. 12 is a schematic diagram of a network device in an embodiment of this disclosure; and

FIG. 13 is a schematic diagram of a terminal equipment in an embodiment of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and New Radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “a terminal equipment (TE) or terminal device” refers to, for example, an equipment accessing to a communication network and receiving network services via a network device. The terminal equipment may be fixed or mobile, and may also be referred to as a mobile station (MS), a terminal, a subscriber station (SS), an access terminal (AT), and a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above.

In the embodiments of this disclosure, the higher-layer signaling may be, for example, radio resource control (RRC) signaling, such as being referred to as an RRC message, which includes, for example, an MIB, system information, and a dedicated RRC message, or being referred to as an RRC IE (RRC information element). The higher-layer signaling may also be, for example, F1-C signaling, or an F1AP protocol; however, this disclosure is not limited thereto.

### Embodiment of a First Aspect

In an IAB network, for downlink congestion, the congestion may be alleviated in two methods: 1. hop-by-hop downlink flow control, which is carried out by a backhaul adaptive protocol (BAP) control protocol data unit (PDU) of a BAP sublayer; and 2. end-to-end flow control, which is carried out by a downlink data delivery status (DDDS) of a new radio (NR) user plane protocol layer.

FIG. 2 is a schematic diagram of hop-by-hop downlink flow control. As shown in FIG. 2, when an IAB-node 3 is subjected to congestion in a downlink direction, for example, when a buffer load exceeds a certain threshold, the IAB-node 3 transmits flow control feedback information to a parent node, i.e., an IAB-node 5. The flow control feedback information is transmitted in a form of a BAP control PDU. The parent node (i.e., the IAB-node 5) may adjust a downlink data rate according to the feedback information to achieve flow control, thereby alleviating congestion.

In addition, in FIG. 2, the IAB-node 3 and an IAB-node 4 are both child nodes of the IAB-node 5, the IAB-node 5 is a child node of an IAB-donor node 6a, an IAB-node 2 is a child node of the IAB-node 3 and the IAB-node 4, and an IAB-node 1 is a child node of the IAB-node 2.

Some limitations exist in the above two methods for alleviating congestion. For example, hop-by-hop flow control can only alleviate short-term congestion and cannot solve long-term congestion, and DDDS cannot provide information on a node where congestion occurs. Hence, methods available for alleviating congestion are relatively limited, and the above hop-by-hop and end-to-end flow control can only be used to alleviate downlink congestion.

At least addressed to the above limitations, the embodiment of the first aspect of this disclosure provides a signal transmission and reception method.

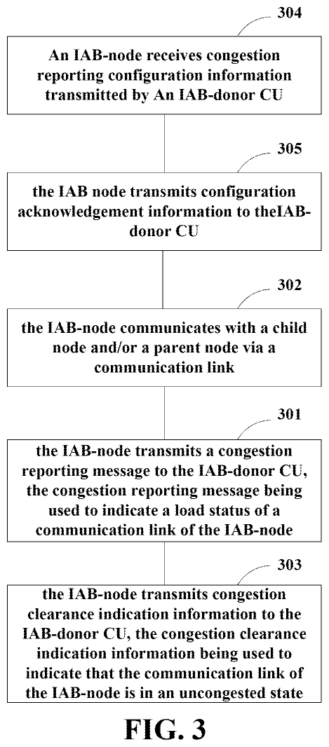

FIG. 3 is a schematic diagram of a signal transmission and reception method of the embodiment of this disclosure. As shown in FIG. 3, the method includes:
operation 301: an integrated access and backhaul (IAB) node transmits a congestion reporting message to a donor central unit of the integrated access and backhaul node (IAB-donor CU), the congestion reporting message being used to indicate a load status of a communication link of the integrated access and backhaul node.

According to the embodiment of the first aspect of this disclosure, the IAB transmits the congestion reporting message indicating the load status of the communication link to the IAB-donor CU, thereby enabling the IAB-donor CU to execute a congestion alleviation method based on a control plane (CP). For example, the IAB-donor CU is able to perform routing reconfiguration, and/or backhaul radio link control (BH RLC) channel re-mapping, and/or resource reallocation, etc., according to the congestion message, thereby alleviating long-term data congestion, reducing data loss, and optimizing network performances.

As shown in FIG. 3, the method may further include:
operation 302: the integrated access and backhaul (IAB) node communicates with a child node and/or a parent node via a communication link.

According to operation 302, the communication link may be an uplink or a downlink. Therefore, the congestion reporting message in operation 301 may indicate the load status of the uplink and/or downlink.

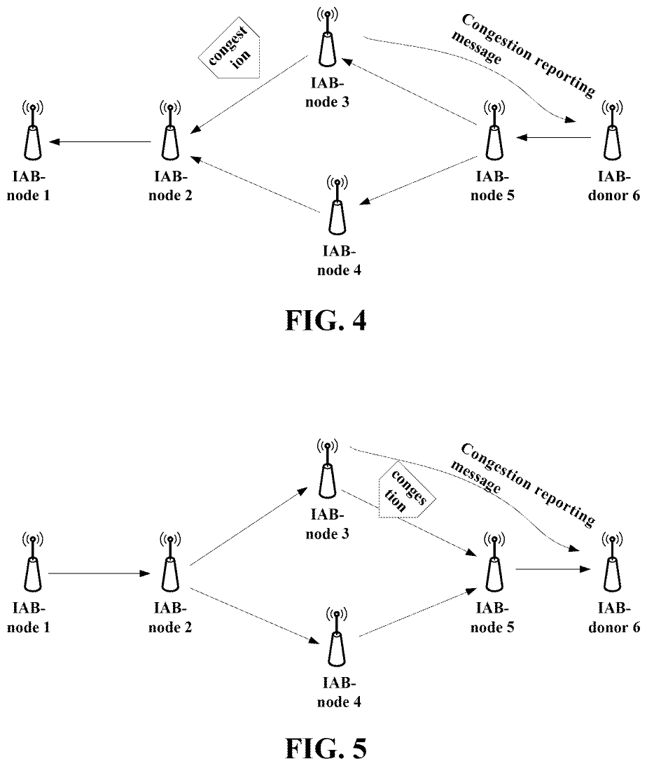

FIG. 4 is a schematic diagram of indicating the load status of the downlink by the congestion reporting message in the embodiment of the first aspect of this disclosure.

As shown in FIG. 4, when congestion occurs in the downlink of an IAB-node 3, for example, if the buffer load exceeds a certain threshold, the IAB-node 3 transmits the congestion reporting message to an IAB-donor central unit (IAB-donor CU) 6 to indicate the load status of the downlink of the IAB-node 3. In addition, explanations for other nodes in FIG. 4 are identical to those in FIG. 2.

FIG. 5 is a schematic diagram of indicating a load status of an uplink by the congestion reporting message in the embodiment of the first aspect of this disclosure.

As shown in FIG. 5, when congestion occurs in the uplink of an IAB-node 3, for example, if the buffer load exceeds a certain threshold, the IAB-node 3 transmits the congestion reporting message to an IAB-donor central unit (IAB-donor CU) 6 to indicate the load status of the uplink of the IAB-node 3. In addition, explanations for other nodes in FIG. 5 are identical to those in FIG. 2.

In FIGS. 4 and 5, the operation of transmitting the congestion reporting message by the IAB-node 3 to the IAB-donor central unit (IAB-donor CU) 6 corresponds to operation 301 in FIG. 3.

In subsequent explanations of the embodiment of the first aspect, the IAB in operation 301 is, for example, the IAB-node 3 in FIGS. 4 and 5.

In at least one embodiment, contents of the congestion reporting message may include: a buffer size, the buffer size referring to a buffer status of a BH RLC channel, etc., in the congestion reporting message; and/or a buffer occupation; and/or an available buffer size, the available buffer size referring to a maximum flow that a transmitter end of IAB-node 3 shall transmit; and/or an available data rate, the available data rate referring to a data rate of the maximum flow that the transmitter end of IAB-node 3 shall use, wherein the available data rate may also be referred to as a desired data rate; and/or information indicating that congestion occurs in the communication link, for example, the communication link may be simple indication information for indicating that congestion occurs in the communication link.

As shown in FIG. 3, the method may further include:
operation 303: the integrated access and backhaul node transmits congestion clearance indication information to the IAB-donor central unit (IAB-donor CU), the congestion clearance indication information being used to indicate that the communication link of the integrated access and backhaul node is in an uncongested state.

For example, in a case where the uplink or downlink of the IAB-node 3 is recovered from a congested state to a normal state (for example, the buffer load is less than a certain threshold), the IAB-node 3 may transmit the congestion clearance indication to the IAB-donor CU 6.

It should be noted that FIG. 3 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 3. For example, operation 301 may be executed before operation 302.

In at least one embodiment, the congestion reporting message may include an information element (IE), which may be used to carry a list of congestion status information, and a name of the list may be, for example, Congestion Information List IE.

The list of congestion status information may include multiple pieces of congestion status information, each containing a content of a congestion reporting message reported at a certain granularity. The granularity may be, for example, per BH RLC channel, or per routing ID, or per communication link. The BH RLC channel or communication link in the congestion status information may be at the IAB-DU side or at an IAB-MT side.

The congestion status information may further include information used for indicating a service direction. For example, for a case of a granularity of a BH RLC channel, the content of the congestion reporting message is reported per BH RLC channel, and the congestion status information may include information used for indicating a service direction, so as to indicate a service direction represented by the congestion status information; wherein the information used for indicating a service direction may be information indicating an uplink or a downlink, or information indicating an ingress or an egress. For another example, for a case of a granularity of a communication link, the congestion status information may also include information used for indicating a service direction. The information used for indicating a service direction may be information indicating whether the communication link is an ingress link or an egress link, or information indicating whether the communication link is an uplink or a downlink.

In addition, as an uplink or a downlink may be distinguished by a routing ID, in the case where the granularity is a routing ID, it is not needed to add the information used for indicating a service direction into the congestion status information.

In at least one embodiment, in the list of congestion status information, one piece of congestion status information may include: a BH RLC channel ID/or a routing ID/or a link ID and a content of a corresponding congestion reporting message. A congestion reporting message may include congestion report information being of different granularities. It should be noted that a BH RLC channel ID is unique for each link, hence, the BH RLC channel ID mentioned in this application actually refers to a combination of a link ID and a BH RLC channel ID, such as link ID+BH RLC channel ID.

Table 1 is an example of a format of the congestion information IE in the congestion reporting message. ‘O’ in Presence indicates that it is optional, for example, ‘O’ indicates a granularity of each item in the list of the convergence information IE or that only one content needs to be selected. In Table 1, a link ID is not directly used, but is instead replaced with a prior-hop BAP address or a next-hop BAP address.

TABLE 1

| | | | IE type and | |
|---|---|---|---|---|
| IE/Group Name | Presence | Range | reference | Semantics description |
| >Congestion Info List | | 0 . . . 1 | Congestion | This IE indicates the congestion |
| | | | information List | information reported by IAB node |
| >>Prior-Hop BAP Address | O | | | Indicates the ingress link. |
| >>Ingress BH RLC CH ID | O | | BH RLC Channel ID | Indicates the ingress BH RLC |
| | | | | channel. |
| >>Next-Hop BAP Address | O | | | Indicates the egress link. |
| >>Egress BH RLC CH ID | O | | BH RLC Channel ID | Indicates the egress BH RLC |
| | | | | channel. |
| >>BAP Routing ID | O | | | Includes BAP address and Path ID. |
| >>Available buffer size | O | | | |
| >>Available data rate | O | | | |
| >>Congestion indication | O | | ENUMERATED | Indicates whether it is congested or |
| | | | (true, . . .) | not (for this item in the list). |

In at least one embodiment, the congestion reporting message transmitted for the uplink and the congestion reporting message transmitted for the downlink may have identical message formats, for example, formats of congestion information IEs for the uplink and the downlink are identical (for example, they are all in the formats shown in Table 1).

In at least one embodiment, when the IAB-node 3 receives polling/request information from the IAB-donor CU 6, the IAB-node 3 transmits the congestion reporting message to the IAB-donor CU.

The polling/request information may include the granularity of the congestion status information in the congestion reporting message, and/or a BH RLC channel ID, and/or a routing ID, and/or a link ID. In addition, for each BH RLC channel ID or link ID, the polling/request message may further include an uplink or downlink indication, or an ingress or egress indication. If the request information includes a granularity (that is, the request information indicates the granularity of the congestion status information), the IAB-node 3 may generate the congestion reporting message according to the granularity; and if the request message includes a BH RLC channel ID, or a routing ID, or a link ID, the IAB-node 3 may generate a congestion reporting message corresponding to these IDs.

In addition, the polling/request information may include a transmission interval period and/or a duration. Hence, the IAB-node 3 is able to transmit the congestion reporting message at the transmission interval period within this duration.

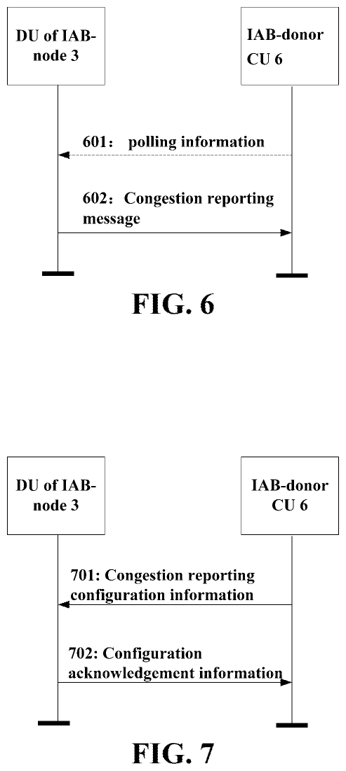

FIG. 6 is a schematic diagram of triggering, by the IAB-donor CU 6 via the polling/request information, the IAB-node 3 to transmit the congestion reporting message. As shown in FIG. 6, in operation 601, the IAB-donor CU 6 transmits the polling/request information to the DU of the IAB-node 3, a name of the polling/request information being, for example, CONGESTION REPORT POLLING or CONGESTION REPORT REQUEST; in operation 602, the DU of the IAB-node 3 generates a congestion reporting message according to the granularity of the polling/request information, and/or the BH RLC channel ID, and/or the routing ID, and/or the link ID, and transmits the congestion reporting message to the IAB-node CU 6.

In at least another embodiment, when a predetermined condition of the IAB-node 3 is satisfied, the IAB-node 3 transmits the congestion reporting message to the IAB-donor CU.

In one embodiment, the predetermined condition includes that a buffer load to which the granularity of the congestion status information in the congestion reporting message corresponds exceeds a first threshold and continues for a first period of time, wherein the first period of time may be implemented by a timer 1. For example, when a buffer load of a granularity reaches a first threshold 1, the timer 1 is started or restarted, and when the timer 1 expires, transmission of the congestion reporting message is triggered; and when the buffer load drops to below the first threshold 1, the timer 1 is stopped if it is running.

In another embodiment, the predetermined condition includes that, in a second period of time, a buffer load of the IAB-node 3 for the same identifier (such as a link identifier, or a BH RLC identifier, or a routing identifier) exceeds a second threshold and the number of pieces or instances of transmitted backhaul adaptation protocol (BAP) control protocol sublayer flow control feedback exceeds a third threshold, wherein the second period of time may be implemented by a timer 2 corresponding to the identifier. For example, a counter of a BAP sublayer for the number of pieces or instances of flow control feedback of an identifier is initialized into an initial value (such as 0), whenever the BAP sublayer initiates flow control feedback for the identifier, the counter of the number of pieces or instances of flow control feedback is incremented by 1, and the timer 2 is started or restarted. When the counter reaches a third threshold 3, transmission of the congestion reporting message is triggered. When the timer 2 expires, the counter is reset to its initial value. The timer 2 is an interval between two pieces of flow control feedback, and is used to indirectly implement the second time period. In addition, after a piece of flow control feedback is transmitted, if the time is long enough (for example, the timer 2 expires), it means that congestion corresponding to flow control feedback transmitted last time is recovered to be normal, hence, timing is restarted at the next time of transmitting the flow control feedback. In addition, reference may be made to related techniques for the operation of transmitting the BAP sublayer flow control feedback when the buffer load of the IAB-node 3 exceeds the second threshold.

As shown in FIG. 3, in at least one embodiment, the method may further include: operation 304: the integrated access and backhaul (IAB) node receives congestion reporting configuration information transmitted by the donor central unit (IAB-donor CU).

For example, the IAB-node 3 receives the congestion reporting configuration information transmitted by the IAB-donor CU 6.

The congestion reporting configuration information is used to configure: a parameter needed in a predetermined condition for determining, by the IAB-node 3, an occasion of transmitting the congestion reporting message, and/or a parameter needed or configuration needed by IAB-node 3 in transmitting the congestion reporting message.

The parameter needed in a predetermined condition for determining, by the IAB-node 3, an occasion of transmitting the congestion reporting message includes, for example, the granularity in the above predetermined condition, and/or the initial value of the timer, and the parameter needed or configuration needed by the IAB-node 3 in transmitting the congestion reporting message includes, for example, the granularity in the congestion reporting message.

In addition, as shown in FIG. 3, the method may further include:
operation 305: the integrated access and backhaul (IAB) node transmits configuration acknowledgement information to the IAB-donor central unit (IAB-donor CU).

The configuration acknowledgement information is used to acknowledge that IAB-node 3 has received the congestion reporting configuration information.

FIG. 7 is a schematic diagram of transmitting the congestion reporting configuration information by the IAB-donor CU 6 to the IAB-node 3. As shown in FIG. 7, in operation 701, the IAB-donor CU 6 transmits the congestion reporting configuration information to the DU of the IAB-node 3, a name of the congestion reporting configuration information being, for example, CONGESTION REPORTING CONFIGURATION; and in operation 702, the DU of the IAB-node 3 transmits the configuration acknowledgement information to the IAB-donor CU 6, a name of the configuration acknowledgement information being, for example, CONGESTION REPORTING CONFIGURATION ACKNOWLEDGE.

Operations 701 and 702 in FIG. 7 or operations 304 and 305 in FIG. 3 may be referred to as a Congestion Reporting Configuration procedure. The Congestion Reporting Configuration procedure may use control plane signaling, for example, the IAB-node 3 may receive the congestion reporting configuration information via F1 application protocol (F1AP, defined in TS38.473) signaling. The Congestion Reporting Configuration procedure may be a newly-added IAB process, and the process may use non-UE-associated signaling.

In at least one embodiment, the congestion reporting message in operation 301 may be carried in the signaling of the control plane.

In one embodiment, the signaling of the control plane may include, for example, F1 application protocol signaling, that is, no matter for the load status of the uplink or for the load status of the downlink, the F1AP signaling is used to carry the congestion reporting message, and the congestion reporting message is transmitted from the DU of the IAB-node 3 to the IAB-donor CU 6. The congestion reporting message for the uplink is generated from the IAB-MT of the IAB-node 3, and the congestion reporting message for the uplink is transmitted by an IAB-DU in the IAB-node 3 collocated with the IAB-MT to the IAB-donor CU 6.

In one example, a new IAB elementary procedure may be added to the F1AP service for transmitting and receiving the congestion reporting message between a gNB DU and a gNB CU.

The newly-added procedure may be named as a congestion reporting procedure. In this procedure, all considerations of the gNB DU are applicable to the IAB DU and the IAB-donor DU. The gNB CU refers to the IAB-donor CU.

In another example, instead of adding a new IAB procedure, an existing procedure may be used to achieve the transmission and reception of the congestion reporting message between the IAB-node 3 and the IAB-donor CU 6. For example, the existing procedure may be a gNB DU status indication procedure, in which congestion status information is added to contents, such as redesigning a gNB DU overload information IE.

In this embodiment, not only may F1AP signaling be used to carry the congestion reporting message for the load statuses of the uplink and downlink, but further congestion reporting requests for the uplink and downlink may be transmitted via the F1AP signaling, and F1AP signaling may be used for the Congestion Reporting Configuration procedures for the uplink and downlink.

For example, as shown in FIG. 6, the DU of the IAB-node 3 receives the congestion reporting requests for the uplink and downlink from the IAB-donor CU 6 via the F1AP signaling, and the DU of the IAB-node 3 may transmit the congestion reporting message to the IAB-donor CU 6 via the F1AP signaling; in addition, as shown in FIG. 7, the DU of the IAB-node 3 receives the congestion reporting configurations for the uplink and downlink via the F1AP signaling, and transmits the configuration acknowledgement information via the F1AP signaling.

In a further embodiment, the signaling of the control plane may further include signaling in the radio resource control (RRC) message. For example, for the downlink, that is, for the link at the DU side in the IAB-node, the BH RLC channel or the congestion reporting message of downlink routing ID may be carried in the F1AP message; and for the uplink, that is, for the link at the MT side in the IAB-node, the BH RLC channel or the congestion reporting message of uplink routing ID may be carried in the RRC message. That is, for the downlink, the procedures shown in FIGS. 6 and 7 may be used, while for the uplink, a procedure similar to those in FIG. 6 and FIG. 7 is implemented between the MT of the IAB-node 3 and the IAB-donor CU 6 via the RRC message.

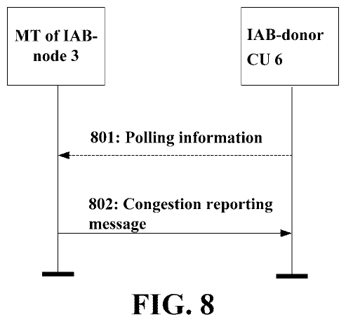

For example, FIG. 8 is another schematic diagram of triggering, by the IAB-donor CU 6 via the polling/request information, the IAB-node 3 to transmit the congestion reporting message. As shown in FIG. 8, in operation 801, the IAB-donor CU 6 transmits the polling/request information to the MT of the IAB-node 3, a name of the polling/request information being, for example, CONGESTION REPORT POLLING or CONGESTION REPORT REQUEST; and in operation 802, the MT of the IAB-node 3 generates the congestion reporting message according to the granularity of the polling/request information, and/or the BH RLC channel ID, and/or the routing ID, and/or the link ID, and transmits it to the IAB-donor CU 6 via the RRC message.

In addition, the MT of the IAB-node 3 may also not receive the polling/request information, but generate the congestion reporting message when the predetermined condition is satisfied and transmit it via the RRC message. In a scenario where the RRC message is used, the predetermined condition may be of an event type.

In the case of using the RRC message for performing congestion reporting for the uplink, the Congestion Reporting Configuration procedure may use dedicated signaling in the RRC message, such as RRCReconfiguration or RRCResume. This procedure may refer to the definition in standard TS38.331, and contents of the configuration information may be added to the procedure, such as the granularity in the congestion reporting message, and/or the above first threshold 1 (i.e., the buffer load threshold), and/or the above second threshold, and/or the above third threshold 3, and/or the initial value of the above timer.

According to the embodiment of the first aspect of this disclosure, the IAB-node transmits to the IAB-donor CU the congestion reporting message used for indicating the load status of the communication link, thereby enabling the IAB-donor CU to execute a congestion alleviation method based on a control plane (CP). For example, the IAB-donor CU is able to perform routing reconfiguration, and/or backhaul radio link control (BH RLC) channel re-mapping, and/or resource reallocation based on the congestion message, etc., thereby alleviating long-term data congestion, reducing data loss, and optimizing network performances.

### Embodiment of a Second Aspect

At least addressed to the same problem as the embodiment of the first aspect, the embodiment of the second aspect of this application provides a signal transmission and reception method, corresponding to the method of the embodiment of the first aspect.

The signal transmission and reception method of the embodiment of the second aspect shall be described below from the side of the IAB-donor central unit (IAB-donor CU) 6 in FIGS. 4 and 5 by taking the scenarios in FIGS. 4 and 5 as examples.

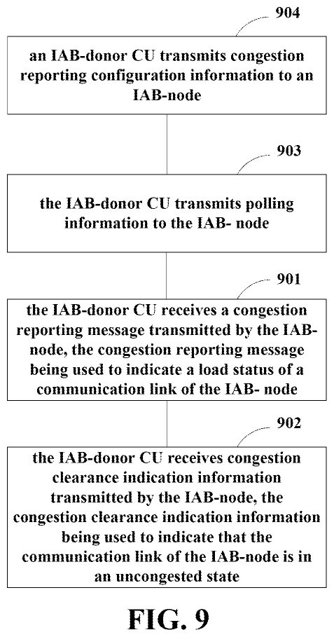

FIG. 9 is a schematic diagram of a signal transmission and reception method of the embodiment of the second aspect. As shown in FIG. 9, the method includes:
operation 901: the IAB-donor central unit (IAB-donor CU) receives a congestion reporting message transmitted by an integrated access and backhaul (IAB) node, the congestion reporting message being used to indicate a load status of a communication link of the integrated access and backhaul node.

In at least one embodiment, contents of the congestion reporting message may include: a buffer size; and/or a buffer occupation; and/or an available buffer size; and/or an available data rate; and/or information indicating that congestion occurs in the communication link.

As shown in FIG. 9, the method further includes:
operation 902: the IAB-donor central unit (IAB-donor CU) further receives congestion clearance indication information transmitted by the integrated access and backhaul node, the congestion clearance indication information being used to indicate that the communication link of the integrated access and backhaul node is in an uncongested state.

In at least one embodiment, the congestion reporting message may include an information element (IE), which may be used to carry a list of congestion status information. A granularity of the congestion status information is per BH RLC channel, or per routing ID, or per communication link. When the granularity of the congestion status information is per backhaul radio link control (BH RLC) channel or per communication link, the congestion status information further includes information used for indicating a service direction (such as an uplink or downlink, ingress or egress).

The congestion reporting message for uplink and the congestion reporting message for downlink have identical message formats. For example, formats of congestion Information IEs in the congestion reporting message are identical.

As shown in FIG. 9, the method further includes:
operation 903: the IAB-donor central unit (IAB-donor CU) transmits polling information to the integrated access and backhaul (IAB) node, wherein when the polling information is transmitted, the integrated access and backhaul (IAB) node transmits the congestion reporting message.

The polling information includes the granularity of the congestion status information in the congestion reporting message, and/or a backhaul radio link control (BH RLC) channel ID, and/or a routing ID, and/or a link ID, in the congestion status information. And the polling information further includes a transmission interval period of the congestion reporting message, and/or a duration of transmitting the congestion reporting message at the period.

As shown in FIG. 9, the method further includes:
operation 904: the IAB-donor central unit (IAB-donor CU) transmits congestion reporting configuration information to the integrated access and backhaul (IAB) node.

The congestion reporting configuration information is used to configure:
a parameter needed in a predetermined condition for determining, by the integrated access and backhaul (IAB) node, an occasion of transmitting the congestion reporting message, and/or a parameter needed or configuration needed by the integrated access and backhaul (IAB) node in transmitting the congestion reporting message. The congestion reporting configuration information may be transmitted via F1 AP signaling or dedicated signaling in the RRC message.

In at least one embodiment, the congestion reporting message is carried in the signaling of the control plane.

The signaling of the control plane includes F1AP signaling. For example, for both the uplink and downlink, the congestion reporting message may be carried in the F1AP signaling. The congestion reporting message may be transmitted by newly adding an IAB procedure to the F1AP.

The signaling of the control plane may further include the RRC message. For example, for the downlink, the congestion reporting message may be carried in the F1AP; and for the load status of the uplink, the congestion reporting message is carried in the radio resource control (RRC) message.

In addition, the IAB-donor central unit (IAB-donor CU) may also transmit the congestion reporting configuration information to the integrated access and backhaul (IAB) node via the dedicated signaling in the radio resource control (RRC) message. The configuration information is the same as that described above, for example, it is used to configure: a parameter needed in a predetermined condition for determining, by the integrated access and backhaul (IAB) node, an occasion of transmitting the congestion reporting message, and/or a parameter needed or configuration needed by the integrated access and backhaul (IAB) node in transmitting the congestion reporting message.

According to the embodiment of the second aspect of this disclosure, the IAB-node transmits the congestion reporting message used for indicating the load status of the communication link to the IAB-donor CU, thereby enabling the IAB-donor CU to execute a congestion alleviation method based on a control plane (CP). For example, the IAB-donor CU is able to perform routing reconfiguration, and/or backhaul radio link control (BH RLC) channel re-mapping, and/or resource reallocation based on the congestion message, etc., thereby alleviating long-term data congestion, reducing data loss, and optimizing network performances.

### Embodiment of a Third Aspect

The embodiment of this disclosure provides a signal transmission and reception apparatus. The apparatus may be, for example, an integrated access and backhaul node, or may be one or some components or assemblies configured in the integrated access and backhaul node, the integrated access and backhaul node being, for example, the IAB-node 3 in FIG. 4 or FIG. 5. The apparatus corresponds to the method in the embodiment of the first aspect.

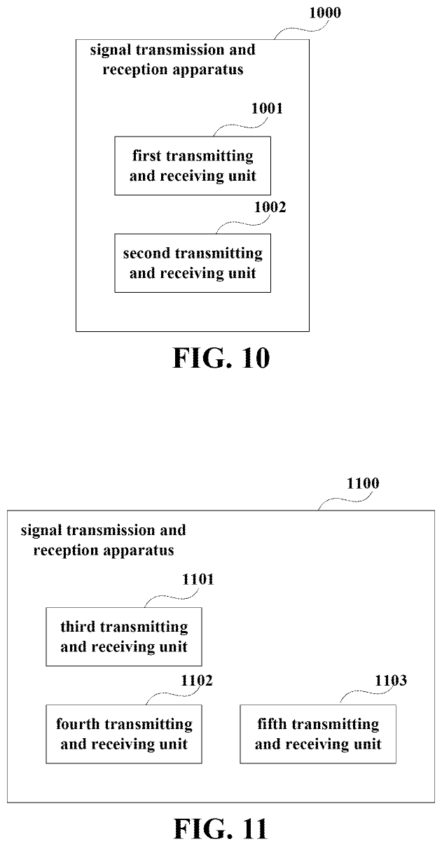

FIG. 10 is a schematic diagram of a signal transmission and reception apparatus of an embodiment of a third aspect. As shown in FIG. 10, a signal transmission and reception apparatus 1000 includes:
a first transmitting and receiving unit 1001 configured to transmit a congestion reporting message to a donor central unit of the integrated access and backhaul node (IAB-donor CU), the congestion reporting message being used to indicate a load status of a communication link of the integrated access and backhaul node.

Contents of the congestion reporting message include: a buffer size; and/or a buffer occupation; and/or an available buffer size; and/or an available data rate; and/or information indicating that congestion occurs in the communication link.

In at least one embodiment, the first transmitting and receiving unit 1001 further transmits congestion clearance indication information to the donor central unit (IAB-donor CU), the congestion clearance indication information being used to indicate that the communication link of the integrated access and backhaul node is in an uncongested state.

In at least one embodiment, the congestion reporting message includes an information element (IE) used for carrying a list of congestion status information, a granularity of the congestion status information being per backhaul radio link control (BH RLC) channel, and/or per routing ID, and/or per communication link.

The congestion reporting message transmitted for the uplink and the congestion reporting message transmitted for the downlink may have identical message formats.

When the granularity of the congestion status information is per backhaul radio link control (BH RLC) channel or per communication link, the congestion status information further comprises information used for indicating a service direction.

When the integrated access and backhaul (IAB) node receives polling information from the donor central unit (IAB-donor CU), or when a predetermined condition of the integrated access and backhaul (IAB) node is satisfied, the integrated access and backhaul (IAB) node transmits the congestion reporting message.

The polling information includes the granularity of the congestion status information in the congestion reporting message, and/or a backhaul radio link control (BH RLC) channel ID, and/or a routing ID, and/or a link ID, in the congestion status information. The polling information further includes a transmission interval period of the congestion reporting message, and/or a duration of transmitting the congestion reporting message at the period.

Furthermore, the predetermined condition includes that a buffer load to which the granularity of the congestion status information in the congestion reporting message corresponds exceeds a first threshold and continues for a first period of time, or in a second period of time, the number of pieces or instances of transmitted backhaul adaptation protocol (BAP) control protocol sublayer flow control feedback due to a buffer load of the integrated access and backhaul (IAB) node for the same identifier exceeding a second threshold exceeds a third threshold.

As shown in FIG. 10, the apparatus 1000 further includes:
a second transmitting and receiving unit 1002 configured to receive congestion reporting configuration information transmitted by the donor central unit (IAB-donor CU).

The congestion reporting configuration information is used to configure: a parameter needed in a predetermined condition for determining, by the integrated access and backhaul (IAB) node, an occasion of transmitting the congestion reporting message, and/or a parameter needed or configuration needed by the integrated access and backhaul (IAB) node in transmitting the congestion reporting message. The congestion reporting configuration information is received via F1 application protocol signaling.

In at least one embodiment, the congestion reporting message is carried in signaling of a control plane.

The signaling of the control plane includes F1 application protocol signaling. For example, for both the uplink and downlink, the congestion reporting message may be carried in the F1AP signaling. The congestion reporting message may be transmitted by newly adding an IAB procedure to the F1 application protocol.

The signaling of the control plane may further include an RRC message. For example, for the downlink, the congestion reporting message may be carried in the F1AP message; and for the uplink, the congestion reporting message may be carried in the radio resource control (RRC) message.

In addition, the second transmitting and receiving unit 1002 may also receive the congestion reporting configuration information from the IAB-donor CU via the dedicated signaling in the radio resource control (RRC) message. The configuration information is the same as that described above, for example, it is used to configure: a parameter needed in a predetermined condition for determining, by the integrated access and backhaul (IAB) node, an occasion for transmitting the congestion reporting message, and/or a parameter needed or configuration needed by the integrated access and backhaul (IAB) node in transmitting the congestion reporting message.

According to the embodiment of the third aspect of this disclosure, the IAB-node transmits the congestion reporting message used for indicating the load status of the communication link to the IAB-donor CU, thereby enabling the IAB-donor CU to execute a congestion alleviation method based on a control plane (CP). For example, the IAB-donor CU is able to perform routing reconfiguration, and/or backhaul radio link control (BH RLC) channel re-mapping, and/or resource reallocation based on the congestion message, etc., thereby alleviating long-term data congestion, reducing data loss, and optimizing network performances.

### Embodiment of a Fourth Aspect

The embodiment of this disclosure provides a signal transmission and reception apparatus.

The apparatus may be, for example, an integrated access and backhaul donor central unit (IAB-donor CU), or may be one or some components or assemblies configured in the integrated access and backhaul donor central unit (IAB-donor CU), the integrated access and backhaul donor central unit (IAB-donor CU) being, for example, the IAB-donor CU 6 in FIG. 4 or FIG. 5. The apparatus corresponds to the method in the embodiment of the second aspect.

FIG. 11 is a schematic diagram of a signal transmission and reception apparatus of the embodiment of the fourth aspect. As shown in FIG. 11, a signal transmission and reception apparatus 1100 includes:
a third transmitting and receiving unit 1101 configured to receive a congestion reporting message transmitted by an integrated access and backhaul (IAB) node, the congestion reporting message being used to indicate a load status of a communication link of the integrated access and backhaul node.

In at least one embodiment, contents of the congestion reporting message may include: a buffer size; and/or a buffer occupation; and/or an available buffer size; and/or an available data rate; and/or information indicating that congestion occurs in the communication link.

The third transmitting and receiving unit 1101 may further receive congestion clearance indication information transmitted by the integrated access and backhaul node, the congestion clearance indication information being used to indicate that the communication link of the integrated access and backhaul node is in an uncongested state.

In at least one embodiment, the congestion reporting message may include an information element (IE), which may be used to carry a list of congestion status information. A granularity of the congestion status information is per BH RLC channel, or per routing ID, or per communication link. When the granularity of the congestion status information is per backhaul radio link control (BH RLC) channel or per communication link, the congestion status information further includes information used for indicating a service direction (such as an uplink or downlink, ingress or egress).

The congestion reporting message for uplink and the congestion reporting message for downlink have identical message formats. For example, formats of congestion Information IEs in the congestion reporting message are identical.

As shown in FIG. 11, the apparatus 1100 further includes:
a fourth transmitting and receiving unit 1102 configured to transmit polling information to the integrated access and backhaul (IAB) node, wherein when the polling information is transmitted, the integrated access and backhaul (IAB) node transmits the congestion reporting message.

The polling information includes the granularity of the congestion status information in the congestion reporting message, and/or a backhaul radio link control (BH RLC) channel ID, and/or a routing ID, and/or a link ID, in the congestion status information. And the polling information further includes a transmission interval period of the congestion reporting message, and/or a duration of transmitting the congestion reporting message at the period.

As shown in FIG. 11, the apparatus 1100 further includes:
a fifth transmitting and receiving unit 1103 configured to transmit congestion reporting configuration information to the integrated access and backhaul (IAB) node.

The congestion reporting configuration information is used to configure:
a parameter needed in a predetermined condition for determining, by the integrated access and backhaul (IAB) node, an occasion of transmitting the congestion reporting message, and/or a parameter needed or configuration needed by the integrated access and backhaul (IAB) node in transmitting the congestion reporting message. The congestion reporting configuration information may be transmitted via F1 AP signaling or dedicated signaling in the RRC message.

In at least one embodiment, the congestion reporting message is carried in the signaling of the control plane.

The signaling of the control plane includes F1AP signaling. For example, for both the uplink and downlink, the congestion reporting message may be carried in the F1AP signaling. Wherein, the congestion reporting message may be transmitted by newly adding an IAB procedure to the F1AP.

The signaling of the control plane may further include the RRC message. For example, for the downlink, the congestion reporting message may be carried in the F1AP; and for the load status of the uplink, the congestion reporting message is carried in the radio resource control (RRC) message.

In addition, the fifth transmitting and receiving unit 1103 may also transmit the congestion reporting configuration information to the integrated access and backhaul (IAB) node via the dedicated signaling in the radio resource control (RRC) message. The configuration information is the same as that described above, for example, it is used to configure: a parameter needed in a predetermined condition for determining, by the integrated access and backhaul (IAB) node, an occasion of transmitting the congestion reporting message, and/or a parameter needed or configuration needed by the integrated access and backhaul (IAB) node in transmitting the congestion reporting message.

According to the embodiment of the fourth aspect of this disclosure, the IAB-node transmits the congestion reporting message used for indicating the load status of the communication link to the IAB-donor CU, thereby enabling the IAB-donor CU to execute a congestion alleviation method based on a control plane (CP). For example, the IAB-donor CU is able to perform routing reconfiguration, and/or backhaul radio link control (BH RLC) channel re-mapping, and/or resource reallocation based on the congestion message, etc., thereby alleviating long-term data congestion, reducing data loss, and optimizing network performances.

Furthermore, for the sake of simplicity, connection relationships between the components or modules or signal profiles in the signal transmission and reception apparatuses 1000 and 1100 are only illustrated. However, it should be understood by those skilled in the art that such related techniques as bus connection, etc., may be adopted. And the above components or modules may be implemented by hardware, such as a processor, a memory, a transmitter, and a receiver, which are not limited in the embodiment of this disclosure.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

### Embodiment of a Fifth Aspect

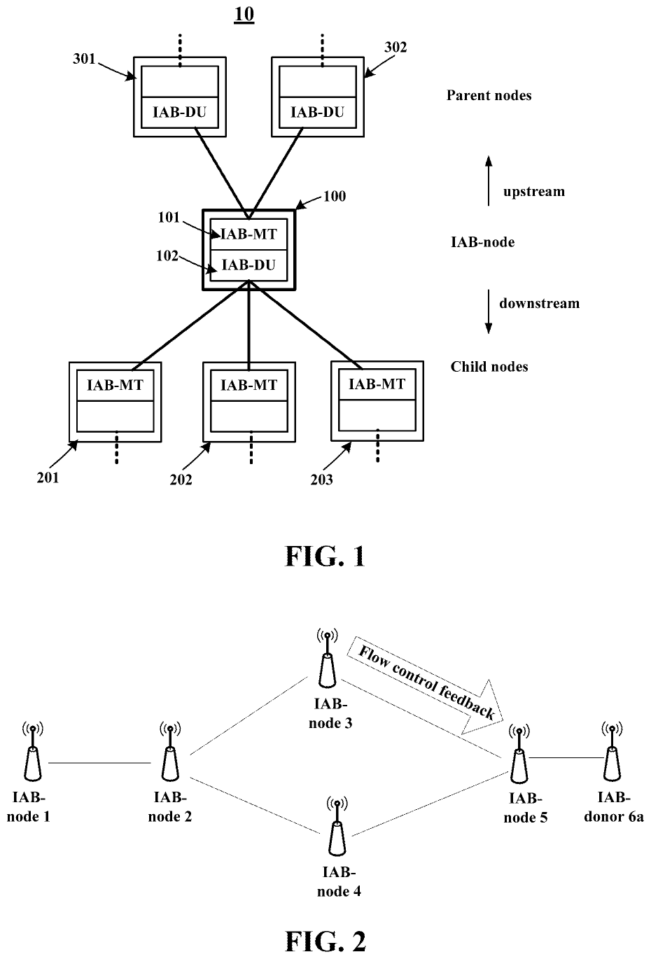

The embodiment of this disclosure provides a communication system, and reference may be made to FIG. 1, with contents identical to those in the embodiments of the first to the fourth aspects being not going to be described herein any further.

In some embodiments, the communication system may include:
an integrated access and backhaul donor central unit (IAB-donor CU), including the signal transmission and reception apparatus 1100 as described in the embodiment of the fourth aspect; and
an integrated access and backhaul node, including the signal transmission and reception apparatus 1000 as described in the embodiment of the third aspect.

The integrated access and backhaul (IAB) node may include an IAB-MT functional unit and an IAB-DU functional unit. The IAB-MT functional unit may have the same structure as a terminal equipment. And the IAB-DU functional unit and the integrated access and backhaul donor central unit (IAB-donor CU) may have the same structure as a network device.

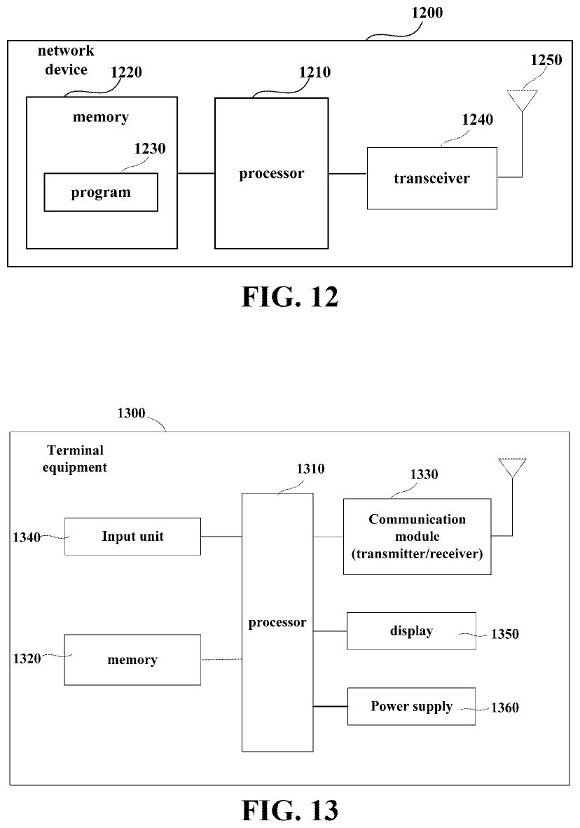

FIG. 12 is a schematic diagram of a structure of the network device of the embodiment of this disclosure. As shown in FIG. 12, a network device 1200 may include a processor 1210 (such as a central processing unit (CPU)) and a memory 1220, the memory 1220 being coupled to the processor 1210. Wherein, the memory 1220 may store various data, and furthermore, it may store a program 1230 for data processing, and execute the program 1230 under control of the processor 1210.

For example, the processor 1210 may be configured to execute a program to carry out the method executed by the IAB-DU in the embodiment of the first aspect or the IAB-donor CU in the embodiment of the second aspect.

Furthermore, as shown in FIG. 12, the network device 1200 may include a transceiver 1240, and an antenna 1250, etc. Functions of the above components are similar to those in the related art, and shall not be described herein any further. It should be noted that the network device 1200 does not necessarily include all the parts shown in FIG. 12, and furthermore, the network device 1200 may include parts not shown in FIG. 12, and the related art may be referred to.

FIG. 13 is a schematic diagram of the terminal equipment in the embodiment of this disclosure.

As shown in FIG. 13, a terminal equipment 1300 may include a processor 1310 and a memory 1320, the memory 1320 storing data and a program and being coupled to the processor 1310. It should be noted that this figure is illustrative only, and other types of structures may also be used, so as to supplement or replace this structure and achieve a telecommunications function or other functions. For example, the processor 1310 may be configured to execute a program to carry out the method executed by the IAB-MT in the embodiment of the first aspect.

As shown in FIG. 13, the terminal equipment 1300 may further include a communication module 1330, an input unit 1340, a display 1350, and a power supply 1360; wherein functions of the above components are similar to those in the related art, which shall not be described herein any further. It should be noted that the terminal equipment 1300 does not necessarily include all the parts shown in FIG. 13, and the above components are not necessary. Furthermore, the terminal equipment 1300 may include parts not shown in FIG. 13, and the related art may be referred to.

An embodiment of this disclosure provides a computer readable program, which, when executed in an IAB, causes the IAB to carry out the signal transmission and reception method as described in the embodiment of the first aspect.

An embodiment of this disclosure provides a computer storage medium, including a computer readable program, which causes an IAB to carry out the signal transmission and reception method as described in the embodiment of the first aspect.

An embodiment of this disclosure provides a computer readable program, which, when executed in an IAB-donor CU, causes the IAB-donor CU to carry out the method as described in the embodiment of the second aspect.

An embodiment of this disclosure provides a computer storage medium, including a computer readable program, which causes an IAB-donor CU to carry out the method as described in the embodiment of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.
1. A signal transmission and reception method, including:
transmitting a congestion reporting message by an integrated access and backhaul (IAB) node to a donor central unit of the integrated access and backhaul node (IAB-donor CU), the congestion reporting message being used to indicate a load status of a communication link of the integrated access and backhaul node.
2. The method according to supplement 1, wherein,
contents of the congestion reporting message include:
a buffer size; and/or
a buffer occupation; and/or
an available buffer size; and/or
an available data rate; and/or
information indicating that congestion occurs in the communication link.
3. The method according to supplement 1, wherein,
the method further includes:
transmitting congestion clearance indication information by the integrated access and backhaul node to the donor central unit (IAB-donor CU), the congestion clearance indication information being used to indicate that the communication link of the integrated access and backhaul node is in an uncongested state.
4. The method according to supplement 1, wherein,
the congestion reporting message for uplink and the congestion reporting message for downlink have identical message formats.
5. The method according to supplement 1, wherein,
the congestion reporting message includes an information element (IE) used for carrying a list of congestion status information,
a granularity of the congestion status information being per backhaul radio link control (BH RLC) channel, and/or per routing ID, and/or per communication link.
6. The method according to supplement 5, wherein,
when the granularity of the congestion status information is per backhaul radio link control (BH RLC) channel or per communication link,
the congestion status information further includes information used for indicating a service direction.
7. The method according to supplement 1, wherein,
when the integrated access and backhaul (IAB) node receives polling information from the donor central unit (IAB-donor CU), or when a predetermined condition of the integrated access and backhaul (IAB) node is satisfied, the integrated access and backhaul (IAB) node transmits the congestion reporting message.
8. The method according to supplement 7, wherein,
the polling information includes the granularity of the congestion status information in the congestion reporting message, and/or a backhaul radio link control (BH RLC) channel ID, and/or a routing ID, and/or a link ID, in the congestion status information.
9. The method according to supplement 7, wherein,
the polling information further includes a transmission interval period of the congestion reporting message, and/or a duration of transmitting the congestion reporting message at the period.
10. The method according to supplement 7, wherein,
the predetermined condition includes that,
a buffer load to which the granularity of the congestion status information in the congestion reporting message corresponds exceeds a first threshold and continues for a first period of time; or
in a second period of time, the number of pieces or instances of transmitted backhaul adaptation protocol (BAP) control protocol sublayer flow control feedback due to a buffer load of the integrated access and backhaul (IAB) node for the same identifier exceeding a second threshold exceeds a third threshold.
11. The method according to supplement 1, wherein,
the method further includes:
receiving, by the integrated access and backhaul (IAB) node, congestion reporting configuration information transmitted by the donor central unit (IAB-donor CU), the congestion reporting configuration information being used to configure:
a parameter needed in a predetermined condition for determining, by the integrated access and backhaul (IAB) node, an occasion of transmitting the congestion reporting message, and/or a parameter needed or configuration needed by the integrated access and backhaul (IAB) node in transmitting the congestion reporting message.
12. The method according to supplement 11, wherein,
the congestion reporting configuration information is received via F1 application protocol signaling.
13. The method according to supplement 1, wherein,
the congestion reporting configuration information is transmitted via F1 application protocol signaling.
14. The method according to supplement 13, wherein,
the congestion reporting message is transmitted in an IAB procedure newly added to the F1 application protocol.
15. The method according to supplement 1, wherein, for a load status of an uplink,
the congestion reporting message is carried in a radio resource control (RRC) message.
16. The method according to supplement 11, wherein,
the congestion reporting configuration information is received via dedicated signaling in an RRC message.
17. A signal transmission and reception method, including:
receiving, by a donor central unit (IAB-donor CU), a congestion reporting message transmitted by an integrated access and backhaul (IAB) node, the congestion reporting message being used to indicate a load status of a communication link of the integrated access and backhaul node.
18. The method according to supplement 17, wherein,
contents of the congestion reporting message include:
a buffer size; and/or
a buffer occupation; and/or
an available buffer size; and/or
an available data rate; and/or
information indicating that congestion occurs in the communication link.
19. The method according to supplement 17, wherein,
the method further includes:
receiving, by the donor central unit (IAB-donor CU), congestion clearance indication information transmitted by the integrated access and backhaul node, the congestion clearance indication information being used to indicate that the communication link of the integrated access and backhaul node is in an uncongested state.
20. The method according to supplement 17, wherein,
the congestion reporting message for uplink and the congestion reporting message for downlink have identical message formats.
21. The method according to supplement 17, wherein,
the congestion reporting message includes an information element (IE) used for carrying a list of congestion status information,
a granularity of the congestion status information being per backhaul radio link control (BH RLC) channel, and/or per routing ID, and/or per communication link.
22. The method according to supplement 21, wherein,
when the granularity of the congestion status information is per backhaul radio link control (BH RLC) channel or per communication link,
the congestion status information further includes information used for indicating uplink or downlink.
23. The method according to supplement 17, wherein,
the method further includes:
transmitting polling information by the donor central unit (IAB-donor CU) to the integrated access and backhaul (IAB) node,
wherein when the polling information is transmitted, the integrated access and backhaul (IAB) node transmits the congestion reporting message.
24. The method according to supplement 23, wherein,
the polling information includes the granularity of the congestion status information in the congestion reporting message, and/or a backhaul radio link control (BH RLC) channel ID, and/or a routing ID, and/or a link ID, in the congestion status information.
25. The method according to supplement 23, wherein,
the polling information further includes a transmission interval period of the congestion reporting message, and/or a duration of transmitting the congestion reporting message at the period.
26. The method according to supplement 17, wherein,
the method further includes:
transmitting congestion reporting configuration information by the donor central unit (IAB-donor CU) to the integrated access and backhaul (IAB) node,
the congestion reporting configuration information being used to configure:
a parameter needed in a predetermined condition for determining, by the integrated access and backhaul (IAB) node, an occasion of transmitting the congestion reporting message, and/or a parameter needed or configuration needed by the integrated access and backhaul (IAB) node in transmitting the congestion reporting message.
27. The method according to supplement 26, wherein,
the congestion reporting configuration information is transmitted via F1 application protocol signaling.
28. The method according to supplement 17, wherein,
the congestion reporting message is transmitted via F1 application protocol signaling.
29. The method according to supplement 28, wherein,
the congestion reporting message is transmitted in an IAB procedure newly added to the F1 application protocol.
30. The method according to supplement 17, wherein, for a load status of an uplink,
the congestion reporting message is carried in a radio resource control (RRC) message.
31. The method according to supplement 26, wherein,
the donor central unit (IAB-donor CU) transmits the congestion reporting configuration information to the integrated access and backhaul (IAB) node via dedicated signaling in a radio resource control (RRC) message.

What is claimed is:

1. A signal transmission and reception apparatus, applicable in an integrated access and backhaul (IAB)-node, comprising:
a transmitter, configured to transmit a congestion reporting message to a donor central unit of the integrated access and backhaul node (IAB-donor CU), the congestion reporting message being used to indicate a load status of a communication link of the integrated access and backhaul node.

2. The apparatus according to claim 1, wherein,
contents of the congestion reporting message comprise:
a buffer size; and/or
a buffer occupation; and/or
an available buffer size; and/or
an available data rate; and/or
information indicating that congestion occurs in the communication link.

3. The apparatus according to claim 1, wherein,
the transmitter is further configured to transmit congestion clearance indication information to the donor central unit (IAB-donor CU), the congestion clearance indication information being used to indicate that the communication link of the integrated access and backhaul node is in an uncongested state.

4. The apparatus according to claim 1, wherein,
the congestion reporting message comprises an information element (IE) used for carrying a list of congestion status information,
a granularity of the congestion status information being per backhaul radio link control (BH RLC) channel, and/or per routing ID, and/or per communication link.

5. The apparatus according to claim 4, wherein,
the congestion status information comprises: a Next-Hop BAP Address identifying the link, and/or
a BH RLC CH ID.

6. The apparatus according to claim 1, further comprising:
a receiver configured to receive polling information from the donor central unit (IAB-donor CU), wherein
when the receiver receives the polling information, or when a predetermined condition of the integrated access and backhaul (IAB) node is satisfied, the integrated access and backhaul (IAB) node transmits the congestion reporting message.

7. The apparatus according to claim 6, wherein,
the polling information comprises a granularity of congestion status information in the congestion reporting message, and/or a backhaul radio link control (BH RLC) channel ID, and/or a routing ID, and/or a link ID in the congestion status information.

8. The apparatus according to claim 6, wherein,
the predetermined condition comprises that,
a buffer load to which the granularity of the congestion status information in the congestion reporting message corresponds exceeds a first threshold and continues for a first period of time; or
in a second period of time, the number of instances of transmitted backhaul adaptation protocol (BAP) control protocol sublayer flow control feedback due to a buffer load of the integrated access and backhaul (IAB) node for the same identifier exceeding a second threshold exceeds a third threshold.

9. The apparatus according to claim 1,
further comprises:
a receiver, configured to receive congestion reporting configuration information transmitted by the donor central unit (IAB-donor CU), the congestion reporting configuration information being used to configure:
a parameter needed in a predetermined condition for determining, by the integrated access and backhaul (IAB) node, an occasion of transmitting the congestion reporting message, and/or a parameter needed or configuration needed by the integrated access and backhaul (IAB) node in transmitting the congestion reporting message.

10. The apparatus according to claim 9, wherein,
the congestion reporting configuration information is received via F1 application protocol signaling.

11. The apparatus according to claim 1, wherein,
the congestion reporting message is transmitted via F1 application protocol signaling.

12. The apparatus according to claim 11, wherein,
the congestion reporting message is transmitted in gNB-DU Status Indication procedure.

13. The apparatus according to claim 1, wherein,
for a load status of an uplink,
the congestion reporting message is carried in a radio resource control (RRC) message.

14. The apparatus according to claim 9, wherein,
the congestion reporting configuration information is received via dedicated signaling in an RRC message.

15. A signal transmission and reception apparatus, applicable in an IAB-donor-CU, comprising:
a receiver, configured to receive a congestion reporting message transmitted by an integrated access and backhaul (IAB) node, the congestion reporting message being used to indicate a load status of a communication link of the integrated access and backhaul node.

16. The apparatus according to claim 15, wherein,
contents of the congestion reporting message comprise:
a buffer size; and/or
a buffer occupation; and/or
an available buffer size; and/or
an available data rate; and/or
information indicating that congestion occurs in the communication link.

17. The apparatus according to claim 15, wherein,
the congestion reporting message comprises an information element (IE) used for carrying a list of congestion status information,
a granularity of the congestion status information being per backhaul radio link control (BH RLC) channel, and/or per routing ID, and/or per communication link.

18. The apparatus according to claim 17, wherein,
when the granularity of the congestion status information is per backhaul radio link control (BH RLC) channel or per communication link,
the congestion status information further comprises information used for indicating uplink or downlink.

19. The apparatus according to claim 15,
further comprises:
a transmitter, configured to transmit polling information to the integrated access and backhaul (IAB) node,
wherein when the polling information is transmitted, the congestion reporting message transmitted by the integrated access and backhaul (IAB) node is received.

20. The apparatus according to claim 15,
further comprises:
a transmitter, configured to transmit congestion reporting configuration information to the integrated access and backhaul (IAB) node,
the congestion reporting configuration information being used to configure:
a parameter needed in a predetermined condition for determining, by the integrated access and backhaul (IAB) node, an occasion of transmitting the congestion reporting message, and/or a parameter needed or configuration needed by the integrated access and backhaul (IAB) node in transmitting the congestion reporting message.
